(19) United States
(12) Patent Application Publication
(10) Pub. No.: US 2008/0230524 A1
(43) Pub. Date: Sep. 25, 2008

(54) Method For Laser Cutting Material Plates, Especially Metal Sheets, and Cutting System For Carrying Out Said Method

(76) Inventor: Karl Merz, Reinach (CH)

Correspondence Address: SUGHRUE MION, PLLC, 2100 PENNSYLVANIA AVENUE, N.W., SUITE 800, WASHINGTON, DC, 20037, US

(21) Appl. No.: 11/793,346

(22) PCT Filed: Dec. 14, 2005
(86) PCT No.: PCT/CH05/00751

§ 371 Date: Jun. 19, 2007

(30) Foreign Application Priority Data
Dec. 21, 2004 (CH) 2121/04

(51) Int. Cl. B23K 26/08; B23K 26/38; B23K 37/04

(52) U.S. Cl. 219/121.72; 83/39; 83/23; 219/121.67

(57) ABSTRACT

Disclosed is a method for laser cutting material plates (13a,b), especially metal sheets. According to said method, the material plates (13a,b) that are to be cut are first placed in a substantially vertical cutting position (SP1, SP2) and are then cut from one side by means of a laser cutting device (14, 15, 16). In order to drastically reduce the machine downtime, the material plates (13a,b) are placed in two or more different cutting position s (SP1, SP2) that can be reached by the same laser cutting device (14, 15, 16) while the material plates located in the different cutting positions (SP1, SP2) are cut one after another.

### TECHNICAL FIELD

The present invention relates to the field of machining material by cutting. It relates to a method for cutting material plates according to the preamble of claim 1 and to a cutting system for carrying out said method. Such a method is known, for example, from document EP-B1-0 454 620.

### PRIOR ART

In connection with mass-produced items in which sheet-metal blanks are processed, such as automobiles for example, cutting systems are used which, in cyclic operation, cut out the desired sheet-metal blanks from individual sheet-metal plates or from a sheet-metal strip unwound from a coil (see, e.g., EP-A1-0 527 114 and EP-A1-1 402 986). In this case, laser cutting apparatuses are being increasingly used for the cutting operation, in which laser cutting apparatuses a cutting head is traversed over the sheet in order to produce the corresponding cutting contour. After completion of a sheet-metal blank, depending on the type of system, either a new sheet-metal plate has to be inserted into the laser cutting apparatus and positioned or a new strip section has to be unwound from the coil and inserted into the laser cutting apparatus and positioned. The sheet is held horizontally on a work table during the cutting; the cutting head is directed over the sheet with a laser beam directed perpendicularly downward. Changing tables may be used in order to accelerate the changing of the sheet-metal plates and thus reduce the machine downtimes (EP-A1-0 527 114). In the process, two tables are used alternately, of which the one is always unloaded and loaded outside the machining region when the other table with the sheet-metal plate is located precisely in the machining region and the supported sheet-metal plate is being cut.

However, cutting systems of this type have various disadvantages:
Since the sheet-metal plates on the machining table have to be supported almost across the entire table surface, the laser beam penetrating through the sheet-metal plate inevitably strikes parts of the table lying underneath the sheet-metal plate, even if the support is effected by a type of grating. This results in damage to the table, and this damage has to be repaired after a certain running time of the system or it necessitates exchange of the table.
If no separate sheet-metal sections are produced during the cutting of the sheet-metal plates, e.g. during the cutting of holes or the like, said sheet-metal plates can fall down onto the table or tilt over and damage the further sequence of the machining.
The horizontal position of the sheet-metal strip or of the sheet-metal plates requires a considerable base area of the system in the case of large sheet-metal widths within the range of several meters.
Even when changing tables are used, downtimes in the region of several seconds still occur, which in the case of large quantities add up to a considerable overall machine downtime.

In order to remove some of the disadvantages listed, a method and a system for cutting flat material has already been proposed (EP-B1-0 454 620) in which the flat material is cut in an approximately perpendicular position. Such a configuration has various advantages:
Since the flat material is suspended perpendicularly or only slightly inclined, no support on the rear side is required in order to absorb deformation forces, and therefore a table with its sensitivity to the cutting laser beam can be dispensed with.
The cut-out parts or scrap pieces can fall downward without hindrance and be disposed of continuously by a conveyor belt or the like arranged at the bottom without the machining being impaired.
Since the plates can be mounted and transported in a perpendicular position, mounting and transport are especially simple and space-saving.
After all the parts have been cut out, the remaining grid of the plate can be transported away from the machining region in a simple manner and at the same time a new plate can be brought into the machining region; however, the remaining grid can be allowed to fall onto a conveyor belt and can be transported away.

Although the solution proposed in EP-B1-0 454 620 has some advantages over the solutions working with horizontal position and tables, there are still problems with regard to the machine downtime, i.e. the time during which no cut is carried out. This is because, if a plate is finish-cut, it must first of all be removed from the cutting position in a suspended manner before a new, still uncut plate (likewise in a suspended manner) can be brought into the cutting position. Valuable seconds during which cutting cannot be carried out also pass here due to the changing process.

### SUMMARY OF THE INVENTION

It is therefore the object of the invention to specify a method and a device for cutting material plates, especially metal sheets, which avoid the disadvantages of known methods and systems and are distinguished in particular by drastically reduced machine downtimes.

The object is achieved by the features of claims 1 and 17 in their entirety. The essence of the invention consists in the fact that, with a largely perpendicular position of the material plates, two or more different cutting positions which can be reached by the same cutting device are used for cutting the material plates, and in that the material plates located in the different cutting positions are cut one after the other by means of the cutting device. Due to the perpendicular arrangement, the different cutting positions can be arranged comparatively close together in a space-saving manner, such that the entire cutting device only has to be adjusted slightly in order to pass from one cutting position to the next. The different cutting positions can be fed with the material plates independently of one another, such that, when a cutting operation has been completed, a new material plate is always ready in another cutting position. As a result, the only downtimes are the times for the adjustment of the cutting device, which times can be kept very short (fractions of seconds) given an appropriate design of the cutting device. In addition to the short machine downtime, there are also advantages which result from the perpendicular position of the material plates and have already been listed further above.

While a first material plate is being cut in a first cutting position, a second material plate is preferably brought into a second cutting position, and, after the cutting of the first material plate, the cutting device is set to the second cutting position and the second material plate is cut.

In particular, the change between the cutting positions is effected periodically in a continuous method, and, before a new material plate is brought into a cutting position for cutting, a material plate cut beforehand in this cutting position is removed from this cutting position.

An especially simple and space-saving setting of the cutting device is obtained if, according to a configuration of the invention, the cutting positions are arranged in a rotationally symmetrical manner about a vertical axis, and if the cutting device is correspondingly adjusted with respect to the axis for reaching the next cutting position.

In principle, 3, 4, 5 or more cutting positions may be arranged about the axis, as a result of which longer change times per cutting position can be achieved at the same cutting capacity. It becomes especially simple, however, if only two cutting positions are provided, which can be shifted one into the other by a 180° rotation about the vertical axis.

A laser beam is preferably used for the cutting, the laser beam being correspondingly deflected for changing between the cutting positions. This deflection can be carried out very quickly, such that the dwell time when changing from one position to the next is very short. In the case of cutting positions opposite one another by 180°, the deflection, for example, can be achieved very simply by means of a pivoting mirror or the like.

A rapid exchange of the material plates in a cutting position and a simplified transport mechanism can be realized by the material plates being transported into the cutting positions and out of the cutting positions in a suspended manner. This applies in particular if the transport of the material plates is effected on straight paths.

In the case of opposite cutting positions, the transport of the material plates into the cutting positions and out of the cutting positions is advantageously effected on parallel paths by means of two separate transport devices.

For the cutting operation, a relative movement between the material plates to be cut and the cutting device is necessary. In the case of large and heavy material plates, it is advantageous if the material plates are each held in a fixed position during the cutting, and if the cutting device travels along a predetermined cutting contour, the cutting device preferably being traversed parallel to the plane of the material plate in two axes in order to travel along the cutting contour.

If the material plates are divided into a blank and a remaining grid by the cutting, it is advantageous that the material plates are held in the region of the blank during the cutting, because damage to the holding device by the cutting tool, in particular the laser beam, is then reliably avoided. At the same time, it is ensured that the blank is held in a fixed position during and after the cutting operation.

It is especially favorable for the manipulation of the material plates after the cutting if, during the cutting of the material plates, the blank is separated from the grid except for a few narrow connecting webs, and if the blank and the grid are only finally separated from one another once the cut material plate has been transported further from its cutting position. After the final separation of the blank and the grid, the blanks can then be collected separately and the grids can be cut up and disposed of.

Transport devices in which the material plates can be suspended are preferably used for transporting the material plates, and the material plates are each individually removed from a stack of material plates before being suspended in the transport devices, the stack of material plates being tilted from a horizontal position into an inclined position in order to more easily singularize the material plates.

A preferred configuration of the cutting system according to the invention is characterized in that the transport means comprise a number of independent transport devices corresponding to the number of cutting positions, which transport devices are each assigned to a certain cutting position, in that the transport devices are designed for the suspended transport of the material plates, in that the transport devices each comprise a revolving chain which extends horizontally and on which devices for suspending the material plates are provided at uniform distances apart. The suspension devices may be designed, for example, as hooks, as clamps, as suction devices or the like.

On account of the simplicity and the saving in space, the cutting positions are preferably arranged around the cutting device in a cutting cell, and the transport devices are directed through the cutting cell, in particular two cutting positions being arranged opposite one another in the cutting cell in such a way that the cutting positions can be shifted one into the other by a 180° rotation about a vertical axis, and a transport device being assigned to each cutting position, which transport devices run parallel to one another.

If the two transport devices transport the material plates in the same direction, further stations for the manipulation of the material plates can be jointly used for the transport devices. In particular, a loading station for the independent loading of the two transport devices with material plates is arranged in the transport direction upstream of the cutting cell, and an unloading station for the independent removal of the blanks cut out of the material plates from both transport devices is arranged downstream of the cutting cell.

In this case, a respective individually controllable loading device preferably traversable transversely to the transport direction is assigned in the loading station to each of the two transport devices, which loading device receives material plates individually from a stack and hangs them on the associated transport device, at least two respective pallet transport devices being provided on the loading devices, by means of which pallet transport devices pallets with stacks of material plates can be supplied to the loading devices in different ways.

In this case, a respective individually controllable unloading device preferably traversable transversely to the transport direction is assigned in the unloading station to each of the two transport devices, which unloading device removes the cut-out blanks from the associated transport device and piles them up to form a stack, at least two respective pallet transport devices being provided at the unloading devices, by means of which pallet transport devices pallets with stacks of blanks can be transported away in different ways.

Furthermore, a disposal station for the disposal of the grids remaining during the cutting is advantageously arranged downstream of the loading station in the transport direction, the disposal station comprising a shredder device for cutting up the grids.

According to another preferred configuration, a holding and positioning device is provided in the cutting cell as means for holding the material plates to be cut for each cutting position, which holding and positioning device holds the material plate to be cut in the region of the blank and presses it against a stop.

According to a further preferred configuration, a respective tilting device for tilting the pallets loaded with stacks of material plates is arranged in the region of the loading devices.

The cutting device is preferably designed as a laser cutting device. It comprises in particular a laser source, a deflecting means and a cutting head, the cutting head being arranged so as to be traversable between the cutting positions and parallel to the material plates located in the cutting position, and the laser light from the laser source located above the transport means or transport devices being deflected into the cutting head by the deflecting means.

To approach different cutting positions, the laser beam can preferably be deflected to the different cutting positions in the cutting head. However, it is also conceivable for the cutting head to be capable of being pivoted with the laser beam to the different cutting positions.

### BRIEF EXPLANATION OF THE FIGURES

The invention is to be explained in more detail below with reference to exemplary embodiments in connection with the drawing, in which:

FIG. 1 shows a simplified scheme of a cutting system according to a preferred exemplary embodiment of the invention in a perspective view;

FIG. 2 shows an oblique plan view of a further exemplary embodiment of a cutting system according to the invention in a detailed illustration;

FIG. 3 shows the system from FIG. 2 in a perpendicular plan view; and

FIG. 4 shows a side view from FIG. 2.

### WAYS OF IMPLEMENTING THE INVENTION

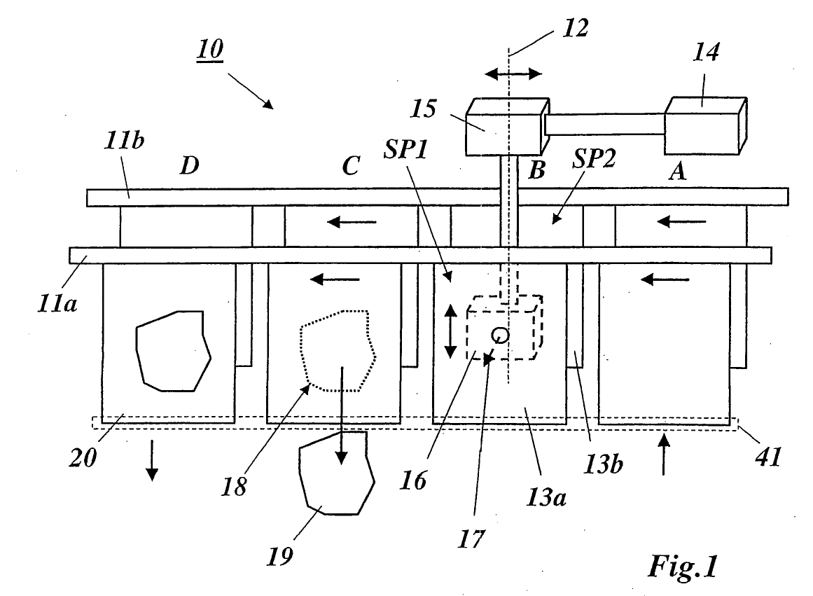

A perspective view of a simplified scheme of a cutting system according to a preferred exemplary embodiment of the invention is reproduced in FIG. 1. The cutting system 10 comprises four system parts arranged one behind the other in a straight line, namely a loading station A, the actual cutting cell B, an unloading station C and a disposal station D. Running in parallel through the cutting system 10 and thus through all the stations A, . . . , D are two transport devices 11a and 11b which are designed for the suspended transport of the material plates 13a, b to be cut. The material plates 13a, b, for example aluminum or steel sheets, which are usually rectangular and have edge dimensions within the meter range, are detachably suspended on the transport devices 11a, b. To this end, the material plates 13a, b can be provided in the region of the top edge with a plurality of holes which are arranged in a distributed manner over the edge length and with which they are suspended on corresponding hooks attached to the transport devices 11a, b in a distributed manner. However, the transport devices 11a, b may also be equipped with clamps or suction cups, with which the material plates can be held in place. The transport devices 11a, b transport the suspended material plates 13a, b in the same transport direction, which is marked in FIG. 1 by the arrows depicted and runs from right to left. The transport devices 11a, b work independently of one another, such that the material plates 13a are transported further in the transport device 11a precisely while the transport device 11b is stopped, and vice versa.

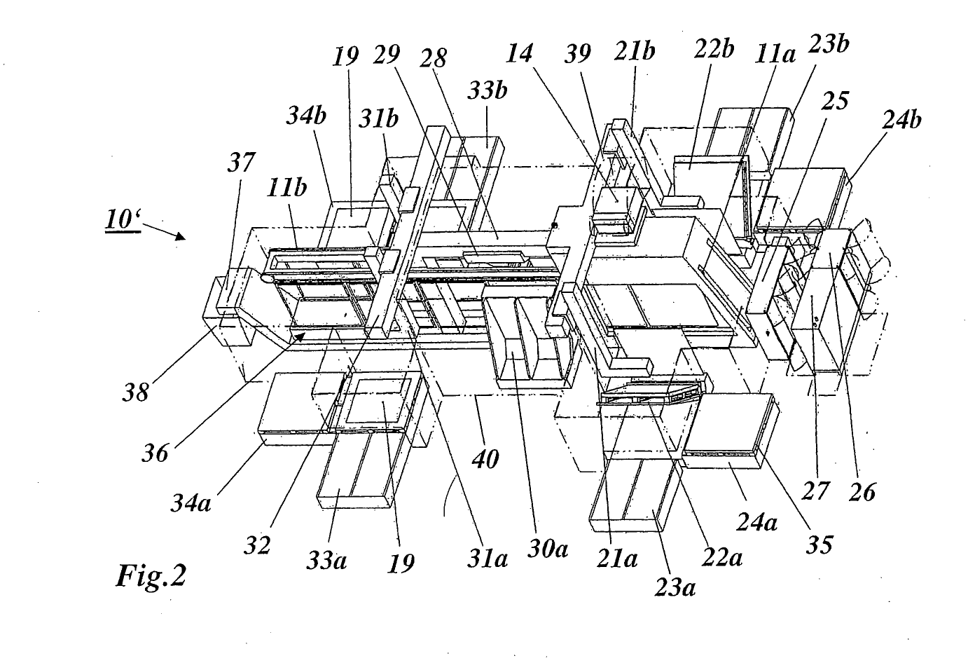

In the loading station A, the material plates are individually removed from a stack of material plates, which is kept ready, by a loading device (not depicted in FIG. 1; 21a, b in, FIG. 2) per transport direction, are swung into the perpendicular position and are then suspended on the associated transport device 11a or 11b. The two transport devices 11a, b are loaded alternately. While the one transport device is stopped in order to permit machining of the material plate located in the cutting cell B, the respective other transport device moves the material plates suspended on it further by one station in the transport direction and thus provides space in the loading station for suspending a new material plate. At the same time, an already cut material plate is transported from the cutting cell B into the unloading station C by the same transport device and an uncut material plate is transferred from the loading station A into the cutting cell B. In this way, an uncut material plate is ready in the cutting cell B in good time when the cutting operation on the other material plate is finished.

In the cutting cell B, the material plates 13a, b assume two different cutting positions SP1 and SP2 in a suspended manner on the two transport devices 11a, b, which cutting positions SP1 and SP2 lie exactly opposite one another in mirror symmetry with respect to a center plane or can be shifted one into the other by a rotation of 180° about a vertical axis 12 lying midway between them. Between SP1 and SP2 a cutting head 16 is arranged, said cutting head 16 being traversable in two axes (double arrows in FIG. 1) in a plane lying parallel to the material plates 13a, b. Discharging laterally from the cutting head 16 is a horizontal laser beam 17, which strikes the material sheet (13a in FIG. 1) to be cut and leaves behind a corresponding cutting contour 18 in the material sheet 13a on account of the preprogrammed traverse distance covered by the cutting head 16. The laser jet 17 originates from a laser source 14 which is arranged above the two transport devices 11a, b and has an output corresponding to a suitable laser, as known from the prior art. The laser light from the laser source 14 is directed via a first beam guide 43, closed off on the outside, in the transport direction to a deflecting means 15, is deflected downward there by 90° and is directed downward to the cutting head 16 via a second beam guide 44. In the cutting head 16, the laser beam running vertically downward can be optionally deflected by 90° to the left or right laterally from the cutting head 16 by a further, changeover deflecting means in order to optionally reach one of the two cutting positions SP1 and SP2. It goes without saying that there may be further beam-forming, e.g. beam-focussing, elements and means in the cutting head 16, as are required for the laser cutting operation. It also goes without saying that the two beam guides 42 and 43 may have telescopic properties in order to permit an unhindered traverse of the cutting head 16. By changing over the deflecting means located in the cutting head 16, a changeover from one cutting operation in the one cutting position to a cutting operation in the other cutting position can be effected very quickly, which is of considerable importance for reducing the machine downtime.

If—as indicated in FIG. 1 by the dotted line—a closed cutting contour 18 is produced in the respective material plate, the blank 19 can be released from the remnant or grid 20 after the cutting and can be further processed. The blank 19 is released and deposited in a stack on a corresponding pallet in the unloading station C. So that the material plate provided with the cutting contour 18 in the cutting cell B can be transported in a suspended manner from the cutting cell B to the unloading station C without difficulties and in a simple manner, the blank 19 is separated from the grid 20 except for only a few narrow or micro connecting webs during the cutting of the material plates 13a, b. The micro connecting webs are severed in or just before the unloading station C and thus the blank 19 and the grid 20 are finally separated from one another. The blank 19 is removed from the material plate and from the transport device by means of unloading devices (not shown in FIG. 1; 31a, b in FIG. 2), whereas the remaining grid 20 is transported further from the unloading station C into the following disposal station D and is cut up there and disposed of. For further guidance of the material plates 13a, b on their way from the loading station A to the disposal station D, guides 41 (depicted by broken lines in FIG. 1) may be provided in the bottom region of the plates, said guides 41 preventing the plates suspended on the transport devices 11a, b from swinging back and forth.

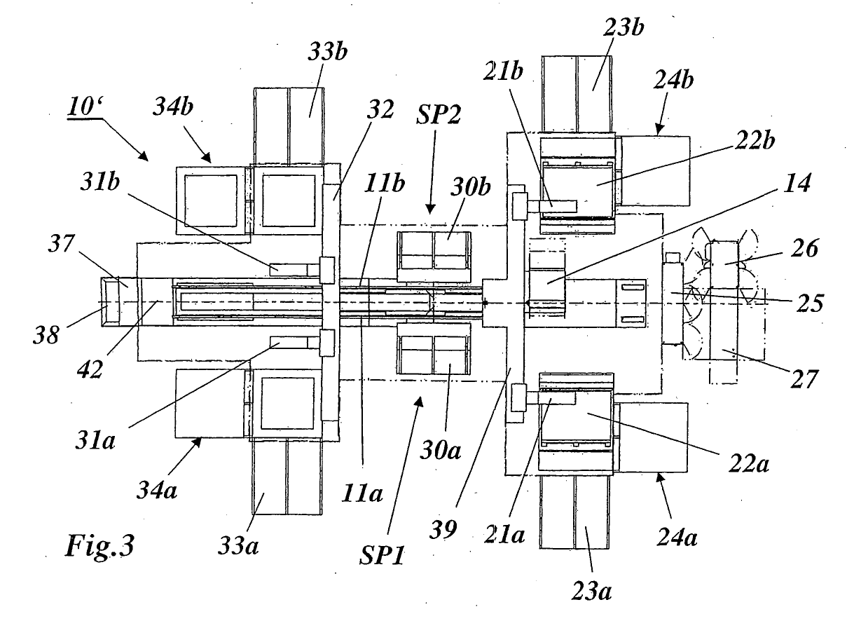

In principle, cutting contours 18 differing from material plate to material plate may be cut if the traverse distance of the cutting head 16 is programmed accordingly. However, problems arise in this case on account of the retaining means in the cutting cell B, which holds the material plate precisely in the cutting position (holding and positioning device 30a, b in FIG. 3). The retaining means fitted with suction cups is designed in such a way that it holds the material plate in place within the planned cutting contour, i.e. in the region of the subsequent blank 19, and presses it against a stop. In this case, the retaining means extends up close to the cutting contour 18 in order to fix the material plate in this critical region as effectively as possible. If the cutting contour 18 changes, it would be advantageous to also adapt that part of the retaining means which is necessary for the fixing, which, however, would lead to stoppage of the cutting system. The optimum capacity of the cutting system is therefore achieved if the same cutting contour 18 is in each case cut continuously in one cutting position. If the same cutting contours 18 are cut in both cutting positions SP1 and SP2 in the cutting system 10 from FIG. 1, this can be done in two different ways: in one case, the cutting contours are in mirror symmetry relative to one another in the two cutting positions SP1 and SP2; this has the advantage that the cutting head 16 covers the same traverse distance in each case. A disadvantage here is that as a rule retaining means of different design are required for the two cutting positions. In the other case, the cutting contours can be shifted one into the other by a rotation of 180° about the axis 12. The retaining means for both cutting positions are identical in this case; however the traverse distance of the cutting head 16 is different.

The continuous functioning of the cutting system 10 in FIG. 1 may be described as follows:
A grid 20 is removed from the first transport device 11a in the disposal station D and disposed of. At the same time, a blank 19 is removed in the unloading station C upstream, a cutting contour 18 is cut in the cutting cell B in the cutting position SP1, and a new material plate is suspended in the loading station A.
In the meanwhile, the second transport device 11b advances by one station and brings an uncut material plate into the cutting position SP2.
The cutting head is reset from the cutting position SP1 to the cutting position SP2.
It cuts the cutting contour 18 there. At the same time, a grid 20 is removed from the transport device 11b in the disposal station D and disposed of, a blank 19 is removed in the unloading station C upstream, and a new material plate is attached in the loading station A.
The first transport device 11a meanwhile advances by one station, such that an uncut material plate passes into the cutting position SP1.
The cutting head is again reset from the cutting position SP2 to the cutting position SP1.
The sequence starts from the beginning again.

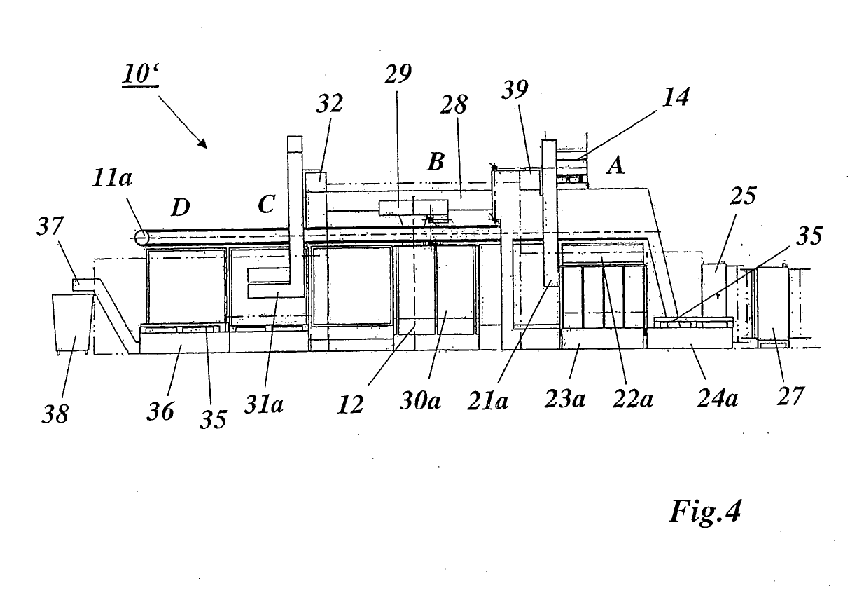

A detailed exemplary embodiment of a cutting system according to the invention which satisfies the principle shown in FIG. 1 is reproduced in FIGS. 2 to 4. The cutting system 10′ again has the four stations A to D arranged one behind the other along an axis 42, with the loading station A, the cutting cell B, the unloading station C and the disposal station D. The transport devices 11a, b are designed as revolving chains in which the material plates are suspended. The laser source 14 is arranged above the loading station A and is thus easily accessible for maintenance and repair work. In the vicinity of the laser source 14 and thus connected to the laser source 14 via short lines, a laser control cabinet 26 and a cooling device 27 are located at the end face of the system. The machine control cabinet 25 necessary for the sequence control of the system is also placed in the same location. The laser control cabinet 26, the cooling device 27 and the machine control cabinet 25 are located in a readily accessible manner outside a protective booth 40, which encloses the entire system and is indicated in FIGS. 2-4 by a dot-dash line. Two respective pallet transport devices 23a, 24a and 23b, 24b arranged at right angles to one another are provided on both sides in the loading station A, by means of which transport devices 23a, 24a and 23b, 24b pallets 35 with stacks of uncut material panels can be supplied or empty pallets can be taken away in an alternating manner. As a result, delays due to a pallet change are reliably avoided. The material plates are removed individually from the stack lying on the pallet 35 by means of a loading device 21a, b and are suspended on the transport device 11a, b. The loading device 21a, b is in each case designed as an angled arm which is traversable and pivotable transversely to the transport direction on a crossbeam 39 and has suction devices (not shown) at the end for adhering to the plates. So that the material plates can be removed more easily from the stack, the pallets with the stacks are inclined by means of a tilting device 22a, b for the removal, as can be seen in FIG. 2.

The material plates suspended on the chains of the transport devices 11a, b in the loading station A are then transported in a suspended manner from the loading station A into the following cutting cell B, where they are brought by the holding and positioning devices 30a, b provided there into the exact cutting position fixed by a stop and are held there. The cutting head (which cannot be seen in FIGS. 2-4) working with laser light is arranged so as to be traversable between the retaining and positioning devices 30a, b. The traverse of the cutting head in the transport direction (axis 42) is ensured by a transport slide 29, to which the cutting head is fastened and which is arranged in a traversable manner on a gantry 28. As already mentioned, the material plates are held in the retaining and positioning devices 30a, b by means of suction cups arranged in a distributed manner within the subsequent cutting contour and are pressed against a stop which is matched to the cutting contour. Once the material plate is cut, it is transported further, with the blank suspended at the micro connecting webs, from the cutting cell B into the following unloading station C. In the unloading station C, the micro connecting webs are severed and thus the blank 19 is finally separated from the rest of the material plate, the grid 20. Whereas the grid 20 remains suspended on the transport device 11a, b, the detached blank 19 is removed laterally by means of an unloading device 31a, b and is deposited in a stacking manner on an available pallet. The unloading devices 31a, b are constructed and designed in a similar manner to the loading devices 21a, b described further above and are likewise traversable and pivotable transversely to the transport direction on a crossbeam 32. They likewise work with suction cups. In a similar manner to the loading station A and for the same reasons, two respective pallet transport devices 33a, 34a and 33b, 34b arranged at right angles to one another are also provided in the unloading station C, by means of which pallet transport devices 33a, 34a and 33b, 34b, pallets 35 with stacks of cut blanks 19 can be taken away or empty pallets can be supplied in an alternating manner.

In the disposal station D, which is arranged downstream of the unloading station C and in which the transport devices 11a, b end, the remaining grids 20 are detached or thrown off from the transport devices 11a, b and drop into a shredder device 36 which lies below the transport devices 11a, b and in which they are cut up. The parts coming from the shredder device 36 are transported away by means of a scrap transport device 37, located underneath, in the form of a conveyor belt or the like and thus pass into a scrap container 38 at the end of the cutting system 10′. The scrap transport device 37 preferably reaches not only right under the disposal station D but also right under the cutting cell B. In this way, small pieces of scrap which are produced directly during the cutting in the cutting cell B and fall downward can also be transported away at the same time.

Although the invention has been explained using the example of a cutting system working with a laser and having two opposite cutting positions, numerous modifications or extensions can be found within the scope of the invention. Thus, for example, instead of laser cutting method, another thermal cutting method or a cutting method working with a water jet may be used. Likewise, instead of the linear transport devices running in parallel, circular, carousel-like transport devices which run through a common cutting cell may be used. It is likewise conceivable to provide, instead of the two cutting positions lying opposite by 180° , three or more cutting positions which can be shifted one into the other by rotation by 360°/n (n=number of cutting positions) about the vertical axis. Furthermore, instead of the transport devices running through the cutting cell, it is possible to use other transport devices which transport the material plates into the cutting cell for cutting and transport them out of the cutting cell again in the same way after the cutting.

### List of Designations

10, 10′ Cutting system
11a, b Transport device
12, 42 Axis
13a, b Material plate (metal sheet)
14 Laser source
15 Deflecting means
16 Cutting head
17 Laser beam
18 Cutting contour
19 Blank
20 Grid
21a, b Loading device
22a, b Tilting device
23a, b Pallet transport device
24a, b Pallet transport device
25 Machine control cabinet
26 Laser control cabinet
27 Cooling device
28 Gantry
29 Transport slide
30a, b Holding and positioning device
31a, b Unloading device
32, 39 Crossbeam
33a, b Pallet transport device
34a, b Pallet transport device
35 Pallet
36 Shredder device
37 Scrap transport device
38 Scrap container
40 Protective booth
41 Guide
43, 44 Beam guide
A Loading station
B Cutting cell
C Unloading station
D Disposal station
SP1, 2 Cutting position

1. A method for cutting material plates (13a, b), especially metal sheets, in which method the material plates (13a, b) to be cut are first of all brought into an essentially cutting position (SP1, SP2) and are then cut from the side by means of a cutting device (14, 15, 16), characterized in that the material plates (13a, b), for cutting, are brought into two or more different cutting positions (SP1, SP2) which can be reached by the cutting device (14, 15, 16), and in that the material plates located in the different cutting positions (SP1, SP2) are cut one after the other by means of the cutting device (14, 15, 16).

2. The method as claimed in claim 1, characterized in that, while a first material plate is being cut in a first cutting position (SP1, SP2), a second material plate is brought into a second cutting position (SP2, SP1), and in that, after the cutting of the first material plate, the cutting device (14, 15, 16) is set to the second cutting position (SP2, SP1) and the second material plate is cut.

3. The method as claimed in claim 2, characterized in that the change between the cutting positions (SP1, SP2) is effected periodically, and in that, before a new material plate is brought into a cutting position (SP1, SP2) for cutting, a material plate cut beforehand in this cutting position (SP1, SP2) is removed from this cutting position (SP1, SP2).

4. The method as claimed in one of claims 1 to 3, characterized in that the cutting positions (SP1, SP2) are arranged in a rotationally symmetrical manner about a vertical axis (12), and in that the cutting device (14, 15, 16) is correspondingly adjusted with respect to the axis (12) for reaching the next cutting position.

5. The method as claimed in claim 4, characterized in that only two cutting positions (SP1, SP2) are provided, which can be shifted one into the other by a 180° rotation about the vertical axis (12).

6. The method as claimed in one of claims 1 to 5, characterized in that a laser beam (17) is used for the cutting, and in that the laser beam (17) is correspondingly deflected for changing between the cutting positions (SP1, SP2).

7. The method as claimed in one of claims 1 to 6, characterized in that the material plates (13a, b) are transported into the cutting positions (SP1, SP2) and out of the cutting positions (SP1, SP2) in a suspended manner.

8. The method as claimed in claim 7, characterized in that the transport of the material plates (13a, b) is effected on straight paths.

9. The method as claimed in claims 5 and 8, characterized in that the transport of the material plates (13a, b) into the cutting positions (SP1, SP2) and out of the cutting positions is effected on parallel paths by means of two separate transport devices (11a, b).

10. The method as claimed in one of claims 1 to 9, characterized in that the material plates (13a, b) are each held in a fixed position during the cutting, and in that the cutting device (14, 15, 16) travels along a predetermined cutting contour (18).

11. The method as claimed in claim 10, characterized in that, to travel along the cutting contour (18), the cutting device (14, 15, 16) is traversed parallel to the plane of the material plate (13a, b) in two axes.

12. The method as claimed in claim 10, characterized in that the material plates (13a, b) are divided into a blank (19) and a remaining grid (20) by the cutting, and in that the material plates (13a, b) are held in the region of the blank (19) during the cutting.

13. The method as claimed in claim 12, characterized in that, during the cutting of the material plates (13a, b), the blank (19) is separated from the grid (20) except for a few narrow connecting webs, and in that the blank (19) and the grid (20) are only finally separated from one another once the cut material plate has been transported further from its cutting position (SP1, SP2).

14. The method as claimed in claim 13, characterized in that, after the final separation of the blank (19) and the grid (20), the blanks (19) are collected separately and the grids (20) are cut up and disposed of.

15. The method as claimed in claim 7, characterized in that transport devices (11a, b) in which the material plates (13a, b) can be suspended are used for transporting the material plates (13a, b), and in that the material plates (13a, b) are each individually removed from a stack of material plates before being suspended in the transport devices (11a, b).

16. The method as claimed in claim 15, characterized in that the stack of material plates is tilted from a horizontal position into an inclined position in order to singularize the material plates (13a, b).

17. A cutting system (10, 10′) for carrying out the method as claimed in one of claims 1 to 16, comprising first means (30a, b) for holding the material plates (13a, b) to be cut in an essentially vertical cutting position (SP1, SP2), second means (11a, b) for transporting the material plates (13a, b) to the vertical cutting position (SP1, SP2) and from the vertical cutting position (SP1, SP2), and a cutting device (14, 15, 16) working in a lateral direction for cutting material plates located in the vertical cutting position (SP1, SP2), characterized in that two or more different cutting positions (SP1, SP2) are provided which can be approached by the transport means (11a, b), and in that the cutting device (14, 15, 16) can be set in each case to the two or more different cutting positions (SP1, SP2).

18. The cutting system as claimed in claim 17, characterized in that the transport means comprise a number of independent transport devices (11a, b) corresponding to the number of cutting positions (SP1, SP2), which transport devices (11a, b) are each assigned to a certain cutting position (SP1, SP2).

19. The cutting system as claimed in claim 18, characterized in that the transport devices (11a, b) are designed for the suspended transport of the material plates (13a, b).

20. The cutting system as claimed in claim 19, characterized in that the transport devices (11a, b) each comprise a revolving chain which extends horizontally and on which devices for suspending the material plates (13a, b) are provided at uniform distances apart.

21. The cutting system as claimed in one of claims 18 to 20, characterized in that the cutting positions (SP1, SP2) are arranged around the cutting device (14, 15, 16) in a cutting cell (B), and in that the transport devices (11a, b) are directed through the cutting cell (B).

22. The cutting system as claimed in claim 21, characterized in that two cutting positions (SP1, SP2) are arranged opposite one another in the cutting cell (B) in such a way that the cutting positions (SP1, SP2) can be shifted one into the other by a 180° rotation about a vertical axis (12), and in that a transport device (11a, b) is assigned to each cutting position (SP1, SP2), which transport devices (11a, b) run parallel to one another.

23. The cutting system as claimed in claim 22, characterized in that the two transport devices (11a, b) transport the material plates (13a, b) in the same direction.

24. The cutting system as claimed in claim 23, characterized in that a loading station (A) for the independent loading of the two transport devices (11a, b) with material plates (13a, b) is arranged in the transport direction upstream of the cutting cell (B), and an unloading station (C) for the independent removal of the blanks (19) cut out of the material plates (13a, b) from both transport devices (11a, b) is arranged downstream of the cutting cell (B).

25. The cutting system as claimed in claim 24, characterized in that a respective individually controllable loading device (21a, b) preferably traversable transversely to the transport direction is assigned in the loading station (A) to each of the two transport devices (11a, b), which loading device (21a, b) receives material plates individually from a stack and hangs them on the associated transport device.

26. The cutting system as claimed in claim 25, characterized in that at least two respective pallet transport devices (23a, 24a and 23b, 24b) are provided on the loading devices (21a, b), by means of which pallet transport devices (23a, 24a and 23b, 24b) pallets (35) with stacks of material plates can be supplied to the loading devices (21a, b) in different ways.

27. The cutting system as claimed in claim 24, characterized in that a respective individually controllable unloading device (31a, b) preferably traversable transversely to the transport direction is assigned in the unloading station (C) to each of the two transport devices (11a, b), which unloading device (31a, b) removes the cut-out blanks (19) from the associated transport device and piles them up to form a stack.

28. The cutting system as claimed in claim 27, characterized in that at least two respective pallet transport devices (33a, 34a and 33b, 34b) are provided at the unloading devices (31a, b), by means of which pallet transport devices (33a, 34a and 33b, 34b) pallets (35) with stacks of blanks (19) can be transported away in different ways.

29. The cutting system as claimed in one of claims 24 to 29, characterized in that a disposal station (D) for the disposal of the grids (20) remaining during the cutting is arranged downstream of the loading station (C) in the transport direction.

30. The cutting system as claimed in claim 29, characterized in that the disposal station (D) comprises a shredder device (36) for cutting up the grids (20).

31. The cutting system as claimed in one of claims 21 to 30, characterized in that a holding and positioning device (30a, b) is provided in the cutting cell (B) as means (30a, b) for holding the material plates (13a, b) to be cut for each cutting position (SP1, SP2), which holding and positioning device (30a, b) holds the material plate to be cut in the region of the blank (19) and presses it against a stop.

32. The cutting system as claimed in claim 25 or 26, characterized in that a respective tilting device (22a, b) for tilting the pallets loaded with stacks of material plates is arranged in the region of the loading devices (21a, b).

33. The cutting system as claimed in one of claims 17 to 32, characterized in that the cutting device (14, 15, 16) is designed as a laser cutting device.

34. The cutting system as claimed in claim 33, characterized in that the cutting device (14, 15, 16) comprises a laser source (14), a deflecting means (15) and a cutting head (16), the cutting head (16) being arranged so as to be traversable between the cutting positions (SP1, SP2) and parallel to the material plates (13a, b) located in the cutting position (SP1, SP2), and the laser light from the laser source (14) located above the transport means or transport devices (11a, b) being deflected into the cutting head (16) by the deflecting means (15).

35. The cutting system as claimed in claim 34, characterized in that the laser beam can be deflected to the different cutting positions (SP1, SP2) in the cutting head (16).

36. The cutting system as claimed in claim 34, characterized in that the cutting head (16) can be pivoted with the laser beam (17) to the different cutting positions (SP1, SP2).
